(19) United States
(12) Patent Application Publication
(10) Pub. No.: US 2026/0296837 A1
(43) Pub. Date: Oct. 1, 2026

(54) Method for Creating a Multi-Floor Building Comprising an Elevator System

(71) Applicant: INVENTIO AG, Hergiswil (CH)

(72) Inventors: Raphael Bitzi, Luzern (CH); Felix Schulte-Herbrüggen, Berlin (DE); Lennart Svensson-Hilford, Puerto de la Cruz (ES); Christian Studer, Kriens (CH); Bjarne Lindberg, Hellbühl (CH)

(21) Appl. No.: 19/489,820

(22) PCT Filed: Jul. 26, 2024
(86) PCT No.: PCT/EP2024/071293

§ 371 Date: Dec. 3, 2025

(30) Foreign Application Priority Data
Aug. 9, 2023 (EP) 23190437.6

(51) Int. Cl. B66B 19/00; B66B 1/34; E04F 17/00

(52) U.S. Cl. CPC B66B 19/00; B66B 1/34; E04F 17/005; B66B 2201/4684

(57) ABSTRACT

A method for creating a multi-floor building comprising an elevator system. The method includes creating the individual floors; providing shaft modules having shaft doors; placing the shaft modules one on top of the other; installing the elevator system; initially starting up and operating the elevator system. Each shaft door is associated with a floor, and each floor with an associated shaft door is assigned a stop. During start-up, an elevator controller is configured such that the car can travel to each stop. Initial start-up takes place before all the floors have been created. During operation of the elevator system, the elevator controller is repeatedly configured such that the car can travel only to a selection of the stops. Selection of stops always has only stops at floors already created, so that the selection of the stops becomes larger according to progress in the creation of the building.

### CROSS-REFERENCE TO RELATED APPLICATIONS

This application is a national phase entry under 35 U.S.C. § 371 of the international patent application PCT/EP2024/071293 filed on Jul. 26, 2024 and published under the publication number WO 2025/031836 A1, claiming priority right from the European patent application EP 23190437.6 filed on Aug. 9, 2023.

### FIELD OF THE INVENTION

The invention relates to a method for creating a multi-floor building comprising an elevator system.

### BACKGROUND OF THE INVENTION

The installation of an elevator system during the creation of a building is complex and therefore involves considerable costs. In particular, the creation of an elevator shaft for an elevator system, and the subsequent installation of elevator components in the elevator shaft, is rather complex. Usually, the elevator shaft is created together with the floors of the building that is to accommodate the elevator system, and, after completion of the elevator shaft, the elevator system with its elevator components, such as the car, counterweight, drive machine and guide rails, is installed in the elevator shaft. It has already been proposed to create the elevator shaft from several prefabricated shaft modules with shaft walls in which elevator components, such as guide rail pieces, are already at least partially pre-installed. Prefabrication and pre-assembly pre-installation do not take place at the construction site of the building comprising the elevator, i.e. at the elevator system installation site, but in a factory and thus at a manufacturing location. This procedure requires less time at the installation site. In addition, this procedure has positive effects on the quality of the installation and on the working safety of the installation personnel.

WO 2023/134842 A1, EP 3 401 267 A1 and AU 625 660 B2 relate to what are known as jump elevators, where the elevator shaft is extended upward as the construction of a building progresses and the upper end of the elevators is gradually moved upward. This means that after each upward movement, i.e. after each “jump,” the elevator is able to travel to further floors of the building.

WO 2022/233803 A1 describes a method for creating an elevator shaft from individual shaft modules that are stacked one on top of the other. It also describes, at least implicitly, a method for creating a multi-floor building comprising an elevator system.

In contrast, it is in particular the object of the invention to propose a method by means of which a multi-floor building comprising an elevator system can be created very efficiently and thus quickly and cost-effectively. According to the invention, this object is achieved by a method having the features of claim 1.

### SUMMARY OF THE INVENTION

The method according to the invention for creating a multi-floor building comprising an elevator system comprises:
creating the individual floors of the building;
providing shaft modules having shaft doors;
stacking the provided shaft modules on a floor slab of the building to form an elevator shaft of the elevator system;
closing the elevator shaft upwardly by means of a top module;
installing the elevator system after the elevator shaft has been closed upwardly;
initially starting-up the elevator system and operating the elevator system.

Each shaft door is associated with a floor, and each floor with an associated shaft door is assigned a stop of the elevator system. The elevator system has an elevator controller and a car. During the initial start-up of the elevator system, the elevator controller of the elevator system is configured such that the car can travel to each stop. The initial start-up of the elevator system takes place before all floors of the building have been created. During operation of the elevator system, the elevator controller is repeatedly configured via a configuration interface such that the car can travel only to a selection of the stops. Said selection of stops in each case includes only stops at floors already created, so that the selection of stops increases according to progress in the creation of the building.

### DETAILED DESCRIPTION OF THE INVENTION

This means that, on the one hand, the creation of the floors of the building does not depend on the installation of the elevator system and, on the other hand, the elevator system can be used as a construction elevator during the construction of the floors. A construction elevator is an elevator that can be used to transport building materials and construction workers during the construction of a building. Construction elevators are often designed as temporary elevators on the exterior facade of a building under construction. Such external elevators are comparatively expensive, complex to install, slow and noisy.

In the following, directional information such as above, below, and lateral or vertical and horizontal refers to the orientation of the respective component during an operating state of the elevator system. In this case, the operating state of the elevator system is understood to be the state following completion of installation and the commissioning of the elevator system. In the operating state of the elevator system, persons and/or goods can thus be transported in the car between stops of the elevator system and thus between floors of the building accommodating the elevator system.

The building created with the method according to the invention is multi-floor, i.e. it has a plurality of, for example three to ten, floors. The creation of a floor within the meaning of this application always builds on an existing floor base. At the lowest floor of the building, the floor slab of the building forms the floor base. For subsequent floors, a floor ceiling of the floor below forms the floor base. The creation of a floor begins with the creation of floor walls, which, for example, can be cast from concrete, laid as masonry, constructed from wood or created from prefabricated wall parts. Once the floor walls have been created, a floor ceiling is created, for example cast from concrete, made from prefabricated ceiling parts or formed with a wooden structure. If the floor created in this way is not the top floor of the building, this floor ceiling forms the floor base of the floor above, as described above. As soon as the floor ceiling has been completed, the corresponding floor is considered to have been completed for the purposes of this application. Further work can also be carried out on a floor created in this way. For example, non-load-bearing walls can be built, plumbing and electrical installations can be carried out and interior work can be completed.

Providing a shaft module is to be understood here to mean that the shaft module is manufactured at the manufacturing location and transported to the creation site. The different shaft modules can be manufactured at different manufacturing locations, and for each shaft module, different manufacturing steps can be carried out at different manufacturing locations.

At least some, but not necessarily all, of the shaft modules have shaft doors. In particular, a pit module and a top module may not have a shaft door. A shaft module can have one or more than one shaft door. A shaft door closes an opening in a shaft module, also known as a shaft opening. If there is no car located at a shaft door, the shaft door is closed and thus prevents access to the elevator shaft from the floor. A shaft door is usually opened and closed together with a car door of the car. If there is at least one shaft door on a floor, the elevator car can stop at this shaft door and access to the car can be made possible by opening the shaft door. This is referred to here as a stop of the car. The shaft door in question is thus associated with a floor.

When the provided shaft modules are stacked one on top of the other on the floor slab of the building, the lowest shaft module is arranged on the floor slab first. This lowest shaft module can also be called a pit module. The arrangement of the pit module on the floor slab is to be understood here as meaning that the pit module is set down on the floor slab. This is done in particular by means of a crane. After being arranged on the shaft floor, the entire pit module can be aligned, in particular by placing leveling plates underneath, for example to compensate for unevenness of the floor slab or to ensure vertical alignment of the side walls. One or more lasers can be used to align the pit module and other shaft modules. The floor slab does not have to be designed to be completely flat; it can, in particular, have a recess into which the pit module is inserted.

At least one, usually more than one, additional pit module is placed on top of the pit module. These additional shaft modules, which are in particular identical in design, are referred to here as base modules. The elevator shaft is closed upwardly by what is known as a top module, which can contain a drive for the elevator system. Closing the elevator shaft upwardly means that the elevator shaft has reached its final height by the top module having been set down. The elevator shaft will therefore not be extended upwardly in a later construction phase. Consequently, no further shaft module will subsequently be placed on the top module. With the placement of the top module in position and thus the closure of the elevator shaft upwards, the elevator shaft receives its final closure upwards.

Once the elevator shaft has been closed upwardly, the installation of the elevator system begins. This means that the elevator components necessary for the operation of the elevator system are installed and, if necessary, aligned. The elevator components mentioned, such as guide rails or buffers, are in particular pre-installed in the shaft modules provided and are thus transported to the creation site in the shaft modules. This also applies in particular to the car of the elevator system.

After installation, the elevator system is put into operation. Among other things, the positions of the various stops of the car are stored in the elevator controller. This can be done by means of an automated learning run or manually via a configuration interface. In addition, safety checks are carried out during start-up. During the aforementioned start-up, the elevator controller is initially configured such that the car can travel to and serve all the stops in the elevator shaft. Because the elevator system is started up before all the floors of the building have been created, the car, during start-up, also travels to stops or shaft doors where a floor of the building has not yet been created, i.e. where no floor yet exists.

In any case, at least one, and in particular more than one, floor is created after start-up of the elevator system and thus, also after the shaft modules have been provided, the shaft modules provided have been stacked one on top of the other and the elevator system has been installed. It is also possible for one or more floors, but not all floors of the building, to be created before start-up of the elevator system.

Once start-up of the elevator system is completed, the elevator system is operated. To ensure that only stops or shaft doors that are located on a floor that has already been created are traveled to, at the end of start-up the elevator controller is configured by an installer via the configuration interface such that the car is able to travel only to a selection of the stops. The selection is made in such a way that the selection always comprises only stops at floors already created. As soon as another floor of building has been created, the selection is expanded to include the stop assigned to this floor. This means that the configuration mentioned is executed repeatedly and the selection of the stops becomes larger according to progress in the creation of the building. It is also possible that a stop assigned to a created floor is not included in the selection immediately after creation.

As long as a stop is not included in the said selection of stops, the shaft doors assigned to this stop will be, in particular, mechanically locked. For this purpose, a special locking device can be provided that can only be unlocked using a special key. As soon as a new floor is created and is to be served by the car, the corresponding shaft door is unlocked by an installer, in particular from the floor.

The aforementioned selection of stops can also comprise only a single stop, in particular the lowest stop. In this case, it is not possible to move the car in the elevator shaft. This would be the case, for example, if only the lowest floor of the building had been created, meaning that no other floor can be traveled to yet.

The aforementioned selection can also include all the stops of the building. This can be the case if all the floors of the building have been created and all the stops can and should be traveled to by the elevator car.

The aforementioned configuration interface can be designed, for example, as an input terminal on the elevator controller or as an interface to a mobile configuration device, for example in the form of a smartphone having a corresponding app. Such configuration interfaces have long been known.

In one embodiment of the invention, the provided shaft modules are placed one on top of the other on the floor slab of the building to form an elevator shaft before the creation of the lowest floor of the building begins. They are therefore placed one on top of the other only when the floor slab of the building exists. This makes a particularly simple creation of the elevator shaft possible, since no floor parts, such as floor walls, can interfere with the stacking of the shaft modules one on top of the other.

It is also possible that during the creation of the elevator shaft, the entire floor slab does not yet exist but only a part of the floor slab on which the pit module is placed. It is also possible that during the creation of the lowest floor of the building the provided shaft modules are placed one on top of the other on the floor slab of the building to form an elevator shaft.

In one embodiment of the invention, the installation and/or commissioning of the elevator system takes place during the creation of a floor of the building. This advantageously allows the construction of the building to continue during the installation and/or start-up of the elevator system. This makes possible a particularly short construction time for the building.

In one embodiment of the invention, side walls of a shaft module adjacent to a further shaft module have an outer horizontal edge that is arranged below an inner horizontal edge of said side walls. This can effectively prevent water from entering the elevator shaft from outside. In particular, all the horizontal edges of the shaft modules are designed in this way. For example, the side walls of the shaft modules have a stepped cross-section.

In one embodiment of the invention, the shaft doors are covered to the outside by means of a cover before the shaft modules are placed one on top of the other. The cover is arranged on the shaft modules, in particular at the manufacturing location. The cover will be removed if the stop assigned to the shaft door is included in the aforementioned selection and is therefore traveled to by the car during operation of the elevator system. This protects shaft doors at which no floor has yet been created from the influences of the weather and prevents water from entering the elevator shaft via these shaft doors. The aforementioned cover can be designed, for example, as a tarpaulin or a panel, for example made of wood or plastic.

In one embodiment of the invention, adjacent shaft modules are connected to one another in a tension-resistant manner. This ensures that the created elevator shaft is particularly stable and sturdy. A tension-resistant connection is understood here to mean that adjacent shaft modules cannot be separated from one another in the vertical direction.

Said connection is made, for example, by means of straps connecting two adjacent shaft modules, in particular galvanized steel straps. The straps can be arranged on the outside or inside of the shaft modules.

### BRIEF DESCRIPTION OF THE DRAWINGS

Further advantages, features, and details of the invention can be found in the following description of exemplary embodiments and with reference to the drawings, in which like or functionally like elements are provided with identical reference signs. The drawings are merely schematic and are not to scale.

In the drawings:

FIG. 1 shows a snapshot during placement of a base module on an as yet unfinished elevator shaft of an elevator system;

FIG. 2 is an enlarged view of side walls of two adjacent shaft modules;

FIG. 3 shows an elevator system with a car in an elevator shaft composed of shaft modules on a floor slab of a building;

FIG. 4 shows the elevator system from FIG. 3 with three floors of the building having been created;

FIG. 5 is a block diagram of a method for creating a building containing an elevator system.

### DETAILED DESCRIPTION OF THE DRAWINGS

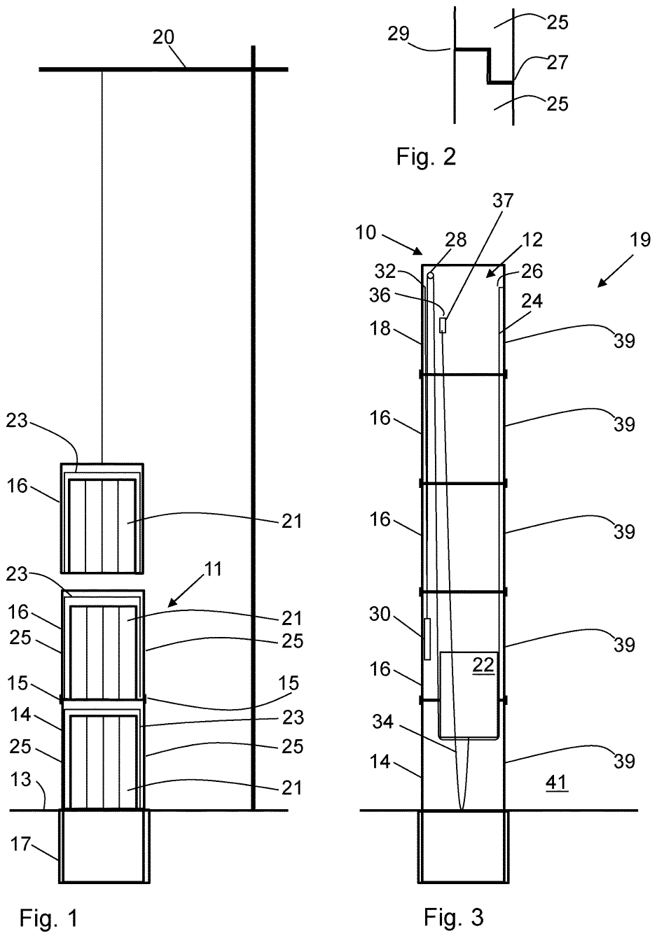

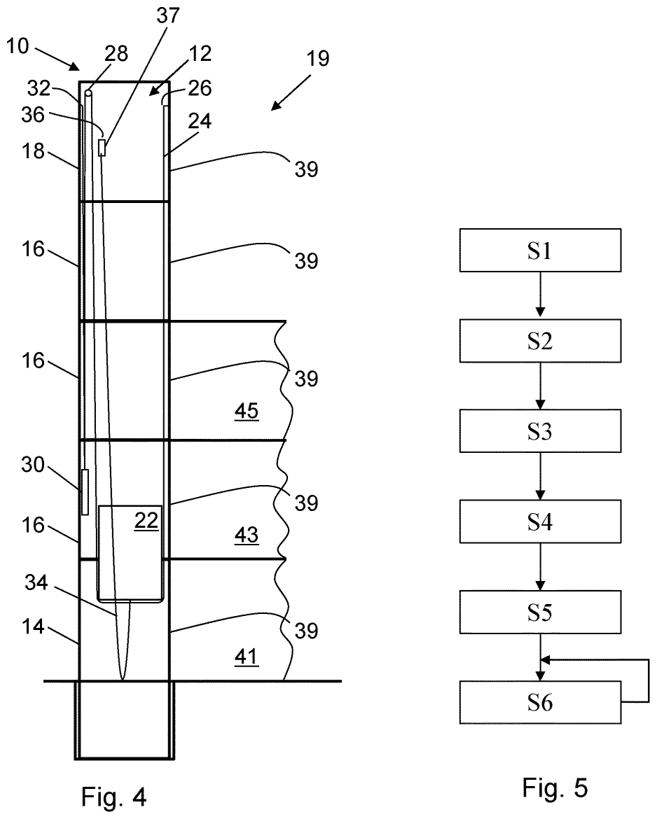

FIG. 1 shows how a second base module 16 is placed from above onto an unfinished elevator shaft 11 by means of a crane 20. For the creation of the unfinished elevator shaft 11, a pit module 14 was first placed on a floor slab 13 of a building to be created (19 in FIG. 3) by means of the crane 20. The floor slab 13 has a recess 17 into which the pit module 14 is inserted and which thus receives a lower part of the pit module 14. A first base module 16 was then placed on the pit module 14 by means of the crane 20, aligned and connected in a tension-resistant manner by means of straps 15, in particular metal straps. For this purpose, two straps 15 are arranged on two opposite side walls 25 of the pit module 14 and of the first base module 16. All of the other shaft modules placed one on top of the other are also connected to each other in this way in a tensile-resistant manner. The pit module 14 and the base modules 16 each have a shaft door 21, which shaft doors are covered by a cover 23 in the form of a panel when the unfinished elevator shaft 11 is being created. During operation of an elevator system (10 in FIGS. 3 and 4), each of the shaft doors 21 is assigned to a stop (39 in FIGS. 3 and 4) of the elevator system. A car (22 in FIGS. 3 and 4) of the elevator system can therefore stop at the shaft door and thus serve the stop. Each stop of the elevator system is associated with a floor of a building that houses the elevator system (19 in FIGS. 3 and 4).

FIG. 2 is an enlarged view of two adjacent side walls 25 of the pit module 14 and of the first base module 16. These are the side walls 25 on the right-hand side in FIG. 1. The side walls 25 have a stepped cross-section such that an outer horizontal edge 27, i.e. the horizontal edge on an outer side, is arranged below an inner horizontal edge 29, i.e. the horizontal edge on an inner side. This applies in particular to all horizontal edges of all shaft modules.

In order to complete the unfinished elevator shaft 11 from FIG. 1, a further base module 16 and finally a top module (18 in FIGS. 3 and 4) are placed on top by means of the crane 20 in the manner described and are connected in a tension-resistant manner to the shaft module below. With the placement of the top module 18, the elevator shaft 12 is closed upwardly and is thus finally closed upwardly. The resulting completed elevator shaft 12 is shown in FIG. 3 as part of an elevator system 10. Said shaft modules 14, 16, 18 were pre-produced in a factory and therefore at a manufacturing location and provided with elevator components. They were then transported from the manufacturing location to the construction site of building 19 that houses the elevator system 10 and thus to a creation site. The described placement of the shaft modules one on top of the other takes place before the creation of the lowest floor 41 of the building 19 begins. In FIG. 3, only the floor slab 13 of building 19 exists.

In the completed elevator shaft 12, the elevator components necessary for operation of the elevator system 10, such as guide rails, are installed and aligned. This can be referred to as the installation of the elevator system 10. The creation of the lowest floor 41 of building 19 begins before or during the installation of the elevator system 10. This means that the installation of the elevator system 10 takes place during the creation of a floor of the building.

The resulting elevator system 10 in FIG. 3 has a car 22 that can be moved vertically in the elevator shaft 12 along guide rails, which are not shown in FIG. 3. For this purpose, the elevator system 10 has lifting gear 24, the first end 26 of which is fixed in the top module 18. It then extends down wards and around the car 22 and is guided via a drive machine 28 arranged in the top module 18 opposite the first end 26 of the lifting gear 24. From there, it runs through a suspension of a counterweight 30 to its second end 32, which is fixed in the region of the drive machine 28. The drive machine 28 can move the lifting gear 24 and thus the car 22 in the elevator shaft 12. The car 22 is connected to an elevator controller 36 arranged in the top module 18 via a traveling cable 34. The traveling cable 34 makes possible a power supply to and a communication with the car 22. The elevator controller 36 has a configuration interface 37 via which it can be configured. The configuration interface 37 is designed as a known interface to a mobile configuration device (not shown), in the form of a smartphone with a corresponding app.

After the installation of the elevator system 10, the start-up of the elevator system 10 follows, which also takes place during the creation of a floor of the building. The positions of the various stops 39 of the car 22 are stored in the elevator controller 36. This is done by means of a known automated learning run. In addition, safety checks are carried out during start-up. During start-up, the elevator controller 36 is initially configured via the configuration interface 37 such that the car 22 can travel to and thus serve all the stops 39 of the elevator shaft 12.

Once start-up of the elevator system 10 is completed, the elevator system 10 is operated. To ensure that only stops 39 and thus shaft doors 21 that are located on a floor that has already been created are traveled to, at the end of start-up the elevator controller 36 is configured by an installer via the configuration interface 37 so that the car 22 can travel only to a selection of the stops 39. The selection is made in such a way that the selection only comprises stops 39 on floors already created. As soon as another floor of building 39 has been created, the selection is extended to include the stop 39 assigned to that floor. This means that the configuration mentioned is executed repeatedly and the selection of the stops 39 becomes larger according to progress in the creation of the building 39.

Upon completion of start-up, the selection of the stops is limited by an installer to the stop 39 on the lowest floor 41 of the building 39; the selection thus comprises only a single stop 39. Once a floor above the lowest floor 41 has been created, an installer expands the selection of stops to include the stop 39 assigned to that floor. After or shortly before the aforementioned expansion of the selection of stops, the cover 23 in front of the shaft door 21 assigned to the relevant stop 39 is removed. In the state of the building 19 shown in FIG. 4, the three lowest floors 41, 43, 45 have already been created. The selection of stops mentioned thus comprises the stops 39 assigned to these three lowest floors 41, 43, 45. This means that the elevator system 10 can be used as a construction elevator, such that material and persons can be transported from the lowest floor 41 to the two floors 43 and 45 above.

When all the floors of building 19 have been created, the above selection of stops will comprise all the stops 39 in building 19, including the floors above the floor 45 which have not yet been created in FIG. 4. The car 22 can thus travel to and serve all stops 39 in the building 19.

The method for creating a multi-floor building comprising an elevator system comprises the following process steps as shown in FIG. 5.

In step S1, a pit module, one or more base modules and a top module are produced in a factory at a manufacturing location and equipped with elevator components.

After step S1 is completed, the shaft modules are transported in step S2 to the construction site of the building that houses the elevator system, i.e. to the creation site. This is carried out, for example, by means of a truck via the highway. Steps S1 and S2 can together be described as providing the shaft modules.

Next, in step S3, the pit module is first placed on a previously created floor slab of the building and then the other shaft modules are stacked one on top of the other to form an elevator shaft.

In step S4, the elevator system is installed and at the same time the lowest floor of the building is created.

In the following step S5, the elevator system is started up and the creation of the lowest floor of the building continues. After the start-up and therefore during operation of the elevator system, the elevator controller is configured such that the car can travel only to a selection of stops, namely only to the stop assigned to the lowest floor.

The following step S6 is always carried out when another floor of the building has been created, i.e. the elevator car is able to travel to the stop assigned to this floor. In step S6, an installer expands the selection of stops in the elevator controller via the configuration interface to include the stop assigned to the completed floor. Step S6 is repeated until all the floors of the building have been created and the selection of stops comprises all the stops of the building. The car can therefore travel to all the stops in the building.

Finally, it should be noted that terms such as “having,” “comprising,” etc., do not preclude other elements or steps, and terms such as “a” or “an” do not preclude a plurality. Furthermore, it should be noted that features or steps which have been described with reference to one of the above exemplary embodiments may also be used in combination with other features or steps of other exemplary embodiments described above. Reference signs in the claims should not be considered to be limiting.

1. A method for creating a multi-floor building comprising an elevator system, comprising:
creating individual floors of the building;
providing shaft modules having shaft doors;
placing the provided shaft modules on a floor slab of the building to form an elevator shaft of the elevator system;
closing the elevator shaft upwardly with a top module,
installing the elevator system after the elevator shaft has been closed upwardly;
initially starting-up the elevator system and
operating the elevator system,
wherein
each shaft door is associated with a floor;
each floor with an associated shaft door is assigned a stop of the elevator system;
the elevator system has an elevator controller and a car,
during the initial start-up of the elevator system, the elevator controller of the elevator system is configured such that the car can travel to each stop,
the initial start-up of the elevator system takes place before all the floors of the building have been created;
during operation of the elevator system, the elevator controller is repeatedly configured via a configuration interface such that the car can travel only to a selection of the stops; and
said selection of stops always comprises only stops of floors already created, so that the selection of the stops increases according to progress in the creation of the building.

2. The method according to claim 1, wherein the provided shaft modules are placed one on top of the other on the floor slab of the building to form an elevator shaft before the creation of the lowest floor of the building begins.

3. The method according to claim 2, wherein the installation and/or initial start-up of the elevator system takes place during the creation of a floor of the building.

4. The method according to claim 1, wherein side walls of one of the shaft modules adjacent to a further one of the shaft modules have an outer horizontal edge that is arranged below an inner horizontal edge of said side walls.

5. The method according to claim 1, wherein the shaft doors are covered outwardly with a cover before the shaft modules are placed one on top of the other, which cover is removed when the stop assigned to the shaft door is traveled to during operation of the elevator system.

6. The method according to claim 1, wherein adjacent shaft modules are connected to each other in a tension-resistant manner.
